(19) United States
(12) Patent Application Publication
(10) Pub. No.: US 2017/0109821 A1
(43) Pub. Date: Apr. 20, 2017

(54) CENTERING OPTIONS ON STRIKE PRICE

(71) Applicant: TRADING TECHNOLOGIES INTERNATIONAL INC., CHICAGO, IL (US)

(72) Inventor: Steven J. CARROLL, Hoffman Estates, IL (US)

(21) Appl. No.: 14/885,489

(22) Filed: Oct. 16, 2015

(51) Int. Cl. G06Q 40/04

(52) U.S. Cl. CPC G06Q 40/04

(57) ABSTRACT

Users of trading devices may use trading applications to buy and sell options for underlying tradeable objects. Options may be identified in market data that are related to underlying tradeable objects and may be grouped for providing relevant option information for each group of options to a user. The option information may include strike prices for a subset of the options for the underlying tradeable object, which may be displayed in a predefined range of strike prices. The predefined range of strike prices may be configurable to allow for a different predefined range of strike prices to be displayed in the user interface. The strike prices included in the predefined range of strike prices relatively closer to a target strike price for a given market than the other strike prices of the options within a group. Other option information may be displayed with the strike prices for each option.

### BACKGROUND

An electronic trading system generally includes a trading device in communication with an electronic exchange. The trading device receives information about a market, such as prices and quantities of a tradeable object, from the electronic exchange. The electronic exchange receives messages, such as messages related to orders, from the trading device. The electronic exchange attempts to match quantity of an order with quantity of one or more contra-side orders.

The information communicated between the trading devices and the electronic exchange about the market may relate to futures contracts. Each trading device may display market information relating to futures contracts allowing a user to submit various trade orders to a futures market at an exchange. For example, a user may trade an option on a futures contract related to an underlying tradeable object. The trading device may display market data related to a wide range of time and price options for the futures contracts. A user may, in turn, interact with the trading device to communicate trade orders for options to an exchange.

A complete list of time and price specified options for each underlying tradeable object can often be voluminous and difficult to assimilate. Additionally, the option information related to each option adds to the amount of information to be provided to a user to accurately trade on such information. Thus, it may be difficult to provide relevant information regarding various options related to underlying tradeable objects to a user, such that a user may be able to accurately trade on such information.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates an example user interface that may be displayed on a computing device to provide option information.

FIGS. 5A-5B illustrate a flow diagram of an example method for generating and displaying option information.

FIG. 6 illustrates a block diagram representative of an example system in which certain embodiments may be employed.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Systems, methods, and apparatus are described for organizing, displaying, and providing option information related to an underlying tradeable object. Users of a trading device may interact with a trading application to buy and/or sell options contracts related to the underlying tradeable object. There are two types of option contracts: a call option and a put option. A call option gives the user the right to buy the underlying tradeable object at a certain price by a certain date. A put option gives the user the right to sell the underlying tradeable object at a certain price by a certain date. The price at which the underlying tradeable object may be purchased or sold is known as the exercise price or strike price. The price at which the option contract may be purchased is known as the option price. The call option price is called a call price, and the put option price is called a put price. The date in an option contract is known as the expiration date or expiry. American style options contracts can be exercised at any time up to the expiration date, while European style option contracts can only be exercised on the expiration date. A wide range of strike prices and expiration dates are available for options contracts relating to each underlying tradeable object. The relevant option information may be identified and/or displayed for different groups of options in a given market, as described herein.

Option contracts may be identified in received market data related to one or more of the underlying tradeable objects. The option contracts or simply “options” may, in turn, be grouped according to expiry, such that the options with the same expiration date may be identified and relevant option information related to the group of options may be provided. The relevant option information may include information for a subset of the options determined to be more relevant to the market than option information for other options. The option information may include strike prices for the subset of options, which may be displayed in a predefined range of strike prices. The predefined range of strike prices may be configurable to allow for a different predefined range of strike prices to be displayed in a user interface. One or more computing devices may be used to process option information related to a group of strike prices to determine the strike prices for the subset of options to include in the predefined range.

The strike prices included in the predefined range of strike prices displayed to a user may be selected as the strike prices closer to a target strike price than other strike prices of the options within a group. The target strike price represents the strike price for the current market for a group of options underlying a futures contract. The strike prices displayed in the predefined range of strike prices may be the closest relative strike prices to a center strike price. The center strike price represents the strike price for the options in a group of options that is closest to the current market (e.g., target strike price) for a futures contract. The predefined range of strike prices may include one or more center strike prices.

An equal number of strike prices may be identified above and below the center strike price for being included in the predefined range of strike prices to display. The strike prices above the center strike price may be the closest relative strike prices above the center strike price of the options within the group of options. The strike prices below the center strike price may be the closest relative strike prices below the center strike price of the options within the group of options.

Other option information may be displayed with the strike prices in the user interface. For example, the call price and/or the put price for the available options at each strike price may be displayed. The call price and/or the put price may be displayed when available in the market data, as the call price and/or the put price may be unavailable for a given option.

Multiple groups of options may be displayed in the user interface for a given underlying tradeable object. Additionally, or alternatively, groups of options may be displayed in the user interface for different underlying tradeable objects. A predefined range of strike prices may be displayed for each group of options, whether the options are for a single underlying tradeable object or multiple underlying tradeable objects. A call price and/or a put price may be displayed for each strike price in each predefined range of strike prices when the call price or the put price are available.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Systems, methods, and apparatus are described for identifying and providing option information related to underlying tradeable objects. As described herein, market data may be received that is related to a tradeable object trading in a market offered at an electronic exchange. Option contracts related to the tradeable object may be identified and included as a part of the received market data. The option contracts with the same expiration date may be grouped together. In this way, each group of options includes a plurality of option contracts having a common expiration date or expiry. Groups of options may be further processed and organized to determine a predefined range of sequential strike prices to display via a user interface. The predefined range of strike prices may be displayed via the user interface.

The processing of a group of options may include sorting the group of options by strike price. A target strike price may be determined that is between a highest and a lowest strike price related to the group of options. At least one center strike price may be determined for the group of options based on the target strike price. The at least one center strike price may include a closest relative strike price to the target strike price of the options in the group of options.

An equal number of strike prices may be identified above and below the at least one center strike price for being included in the predefined range of strike prices to display. The strike prices above the at least one center strike price may be the closest relative strike prices above the at least one center strike price of the options within the group of options. The strike prices below the at least one center strike price may be the closest relative strike prices below the at least one center strike price of the options within the group of options. The at least one center strike price and the identified strike prices above and below the at least one center strike price in the predefined range of strike prices to display.

The groups of options may be further sorted by option code. The option code may indicate whether the option is related to a call price or a put price for the option. At least one of a call price or a put price for each strike price in a predefined range of strike prices when the call price or the put price are available.

An indexed array of options objects may be generated for each strike price in a group of options. Each options object in the indexed array of options objects may include the strike price corresponding to at least one option in the group of options. Each indexed array of options objects for the group of options may be generated by identifying a next strike price in the sorted group of options and generating an index for the next strike price. The options objects may include options having a same strike price and a different option code.

The groups of options may include multiple groups of options for the same underlying tradeable object. For example, the underlying tradeable object may be a futures contract. A first group of options contracts for the underlying futures contract may have the same first options contract expiry and a second group of options contracts for the underlying futures contract may have the same second options contract expiry. A predefined range of strike prices may be displayed for each group of options contracts. At least one of a call options contract including a call price, or a put options contract including a put price may be displayed for each strike price in each predefined range of strike prices when the call price or the put price are available.

The groups of options may include multiple groups of options for different underlying tradeable objects. Market data may be received that is related to each of the tradeable objects. Options may be identified in the market data that are related to different underlying tradeable objects. The options related to each underlying tradeable object may be grouped by expiration date and may be processed to determine predefined ranges of strike prices to display via the user interface. The predefined range of strike prices may be different for the options of each underlying tradeable object.

The embodiments described herein may be performed by an options manager that resides on one or more computing devices. For example, the options manager may reside on a trading device. The trading device may comprise one or more computing devices, such as a trading terminal or a trading terminal and a trading server. The options manager may comprise software that may be distributed across the trading terminal and the trading server. The software may be executed by a processor at the trading terminal or respective processors at the trading terminal and the trading server.

### II. Example Electronic Trading System

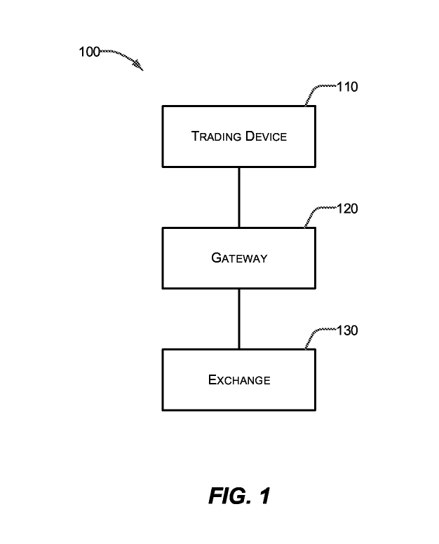

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, futures contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

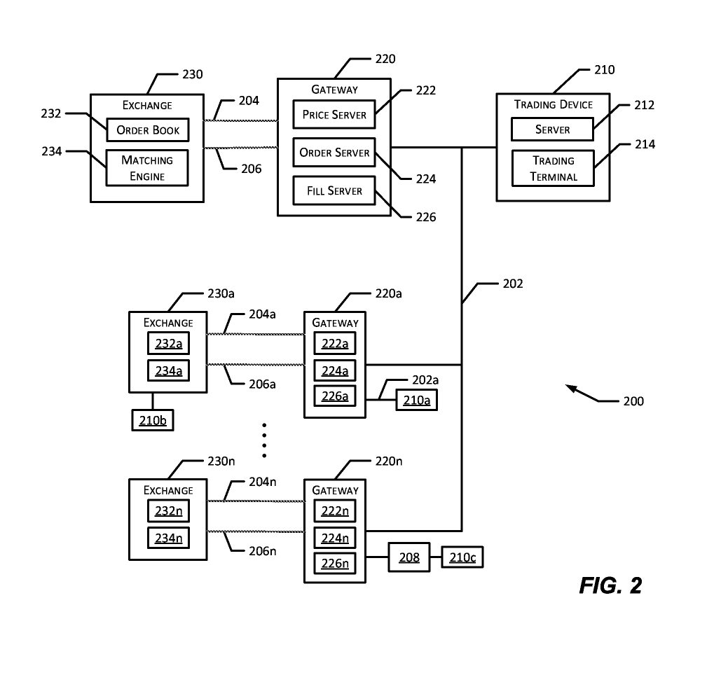

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

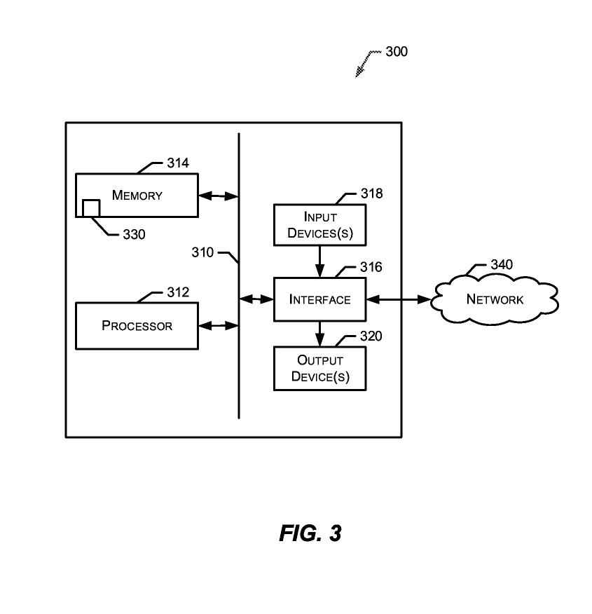

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Interface for Centering Options

Users of a trading device may use a trading application to buy and/or sell options for underlying tradeable objects. A call option gives the user the right (but not the obligation) to buy the futures contract at a certain price within a specific period of time before the option expires. A put option gives the user the right (but not the obligation) to sell the futures contract at a certain price within a specific period of time before the option expires. The price at which the underlying tradeable object (i.e., the asset) may be purchased or sold as part of an option contract may be referred to as the strike price. The strike price may be the price a futures contract may go above (for calls) or below (for puts) before a position may be exercised for a profit. The price at which the option contract itself may be purchased or sold is the call price or put price.

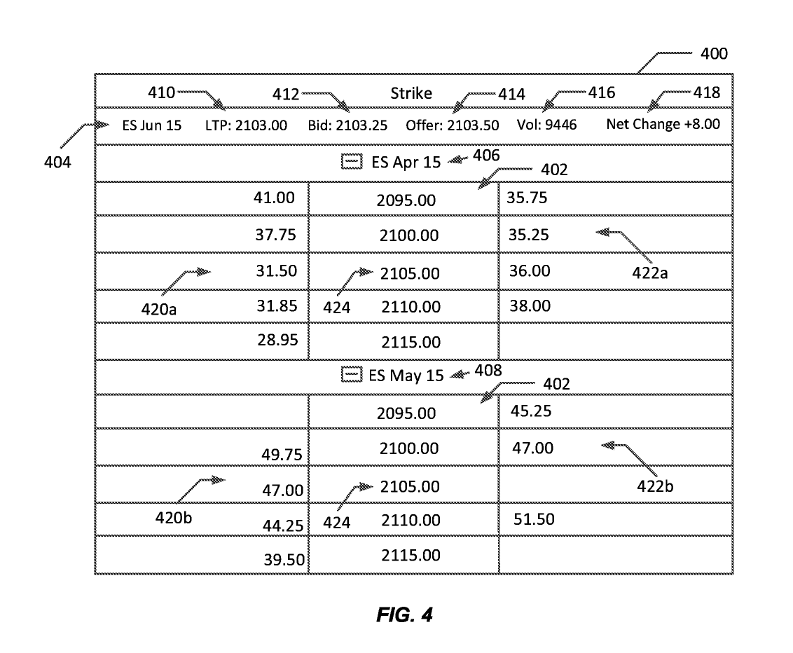

FIG. 4 illustrates an example of an interface 400 that may be displayed on a computing device to identify information related to options for an underlying tradeable object 404. The interface 400 may be generated at one computing device for display at a second computing device. For example, the interface 400 may be generated and displayed locally on a computing device, or may be generated at a computing device for being displayed remotely on another device (e.g., via a remote application or web interface). In an example, the interface 400 may be generated by a trading application that may be executed on a trading server for display on a trading terminal, or the interface 400 may be generated locally at the trading terminal for display to a user.

A computing device may generate and display the interface 400 based on market data received thereby. The market data may relate to one or more tradeable objects, such as a futures contract identified as the tradeable object 404, for example. The tradeable object 404 may be a futures contract identified by the financial product type (e.g., “ES”), the month code, and/or the year identifier. The market data for the tradeable object 404 may include the inside market, market depth, a last traded price (LTP) 410, and/or price levels associated with the inside market and market depth. The inside market for the tradeable object 404 may include a highest available bid 412 and/or a lowest available offer 414 at an electronic exchange. The market depth for the tradeable object 404 may include the volume 416 available at price levels, including the inside market. The price levels associated with the inside market and market depth can be provided as a value level, such as the net change 418 from an opening price for the tradeable object 404.

Because options of different expiries can have the same underlying tradeable object 404, the interface 400 may display a row for the tradeable object 404 and options below the tradeable object 404 that may be grouped by different expiries 406, 408. Though the interface 400 shows options grouped by two different expiries 406 and 408, any number of groups of options may be included in the interface 400. Additionally, though the interface 400 shows a single tradeable object 404, any number of futures contracts 404 may be included in the interface 400 with the groups of options related thereto.

The interface 400 may display option information for options of an underlying tradeable object 404. For example, the interface 400 may display a predefined range of strike prices 402 for options of the underlying tradeable object 404. The predefined range of strike prices 402 may include a subset of the total strike prices for the groups of options that may be available for the underlying tradeable object 404. The interface 400 may center the predefined range of strike prices 402 for the options around the current market of the tradeable object 404. For example, the predefined range of strike prices 402 may be centered around a center strike price 424. The center strike price 424 may represent the strike price that is closest to the current market for the tradeable object 404. The predefined range of strike prices 402 may include the closest relative strike prices to the center strike price 424 for a group of options for the underlying tradeable object 404. Though the interface 400 may include a single center strike price 424, the interface 400 may display multiple center strike prices. For example, if the predefined range of strike prices 402 includes an even number of strike prices, the predefined range of strike prices 402 may include multiple center strike prices.

The center strike price 424 may be based on a target strike price for the tradeable object 404. The target strike price may represent the strike price for the current market for a group of options underlying the tradeable object 404. The target strike price may be at a midpoint between the lowest available offer 414 and the highest available bid 412 for the tradeable object 404, the lowest available offer 414 for the tradeable object 404, the highest available bid 412 for the tradeable object 404, the last traded price 410 for the tradeable object 404, the midpoint between the high and low traded price for the tradeable object 404 within a predefined period of time (e.g., a day), the highest traded price for the tradeable object 404 within the predefined period of time (e.g., indicated by the net change 418), the lowest traded price for the tradeable object 404 within the predefined period of time (e.g., indicated by the net change 418), and/or the settlement price for the tradeable object 404.

The predefined range of strike prices 402 may be displayed as a sequential list of relevant strike prices for options of the underlying tradeable object 404. The predefined range of strike prices may be updated in real-time upon receipt of updated market data at a computing device to identify the current relevant strike prices for the options of the underlying tradeable object 404. For example, the predefined range of strike prices 402 may be updated based on market data (e.g., bid prices and/or offer prices), such that as the market goes up or down (e.g., due to changes in the bid prices and/or offer prices), the values in the center strike prices may be updated to show the user the relevant market data for purchasing options. The market may be tracked for the underlying tradeable object 404 by the target strike price, such that when the target strike price changes (e.g., highest available bid price 412 and/or the lowest available offer 414 changing), the center strike price 424 in the predefined range of strike prices 402 may change. The center strike price 424 may change when the target strike price changes by a predefined threshold (e.g., is outside of the predefined range of strike prices 402). The predefined range of strike prices 402 may be updated and displayed for each expiry 406, 408.

The predefined range of strike prices 402 may be configured by the user or may be otherwise predefined at the computing device. The interface 400 illustrates a predefined range of strike prices 402 that includes five strike prices for each expiry 406, 408. However, the predefined range of strike prices 402 may include any number of strike prices. The predefined range of strike prices 402 may be different for each futures contract when the option information for different underlying tradeable objects is displayed.

The market data received at a computing device may include information related to the options for the underlying tradeable object 404, which may be used to generate and display the interface 400. For example, the market data may include the strike prices related to the underlying tradeable object 404, a call option contract including the call price for each of the strike prices (if any), and/or a put option contract including the put price for each of the strike prices (if any). The call prices and the put prices may correspond to a strike price for a respective expiry 406, 408.

The options for each expiry 406, 408 may be stored at the computing device with the corresponding strike price, call price, and/or put price. If the options do not include a current call price or a current put price, the respective call price value or put price value may be stored as a null value or zero value. The user interface 400 may display the call price 420a and the put price 422a (if any) for each individual strike price displayed in the predefined range of strike prices 402 for the expiry 406. The user interface 400 may display the call price 420b and the put price 422b (if any) for each individual strike price in the predefined range of strike prices 402 for the expiry 408.

The call prices 420a, 420b and the put prices 422a, 422b may change as the individual strike prices in the predefined range of strike prices 402 for the respective expiry 406, 408 are updated. The option information (e.g., strike prices, call prices, and/or put prices) may be updated together in real-time to keep relevant option information in the interface 400. The option information for each expiry 406, 408 may be expandable and/or collapsible, such that the option information may be displayed or collapsed upon user selection.

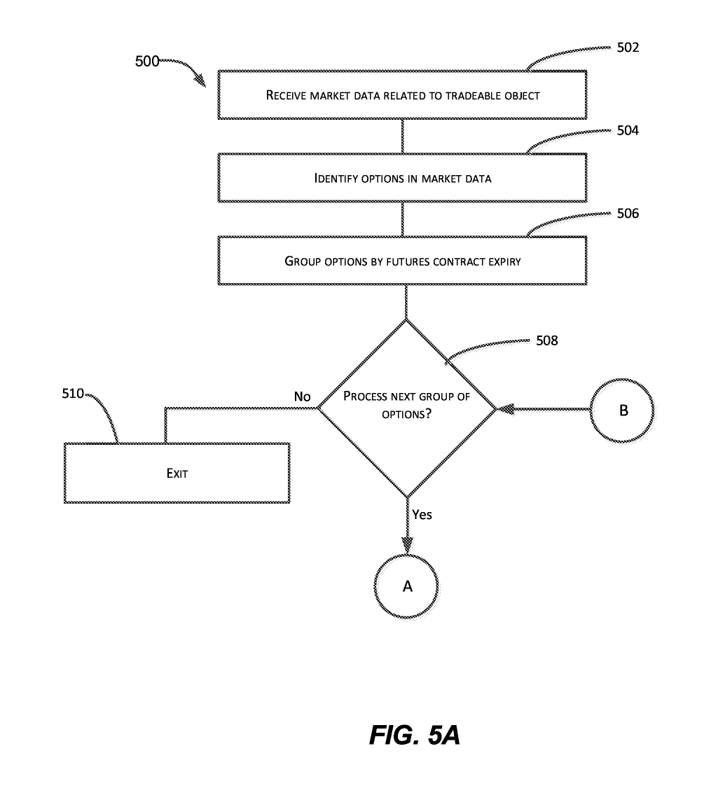

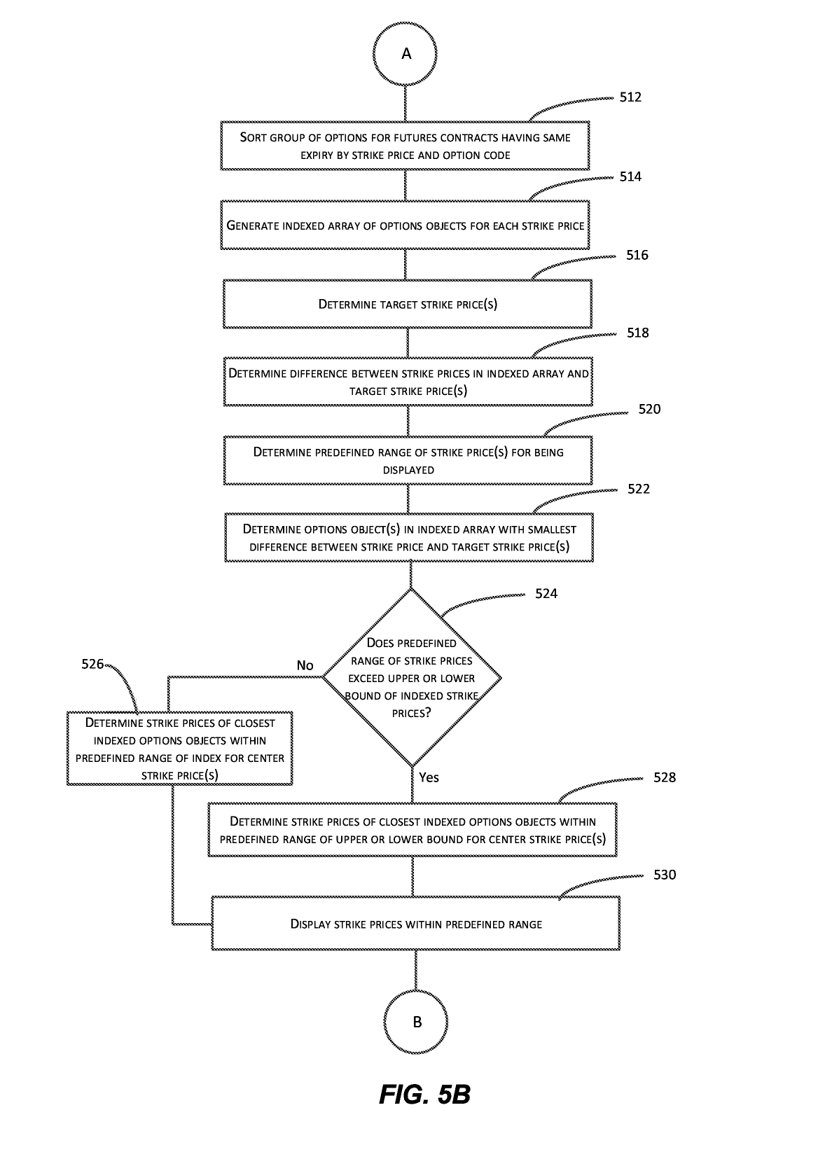

FIGS. 5A and 5B illustrate an example flow diagram of a method 500 for generating and displaying option information for options on underlying tradeable objects. The method 500, or portions thereof, may be performed by one or more computing devices, such as a trading device or another computing device. In an example, the method 500, or portions thereof, may be performed by an options manager residing at one or more computing devices.

As shown in FIG. 5A, a computing device may receive market data related to a tradeable object, such as a futures contract, at 502. The market data may be received from one or more electronic exchanges, for example. The market data may include information such as the strike prices related to options for an underlying tradeable object. The market data may identify the tradeable objects, futures contracts and other assets underlying various options. For example, each futures contract included in the market data may be identified by a futures contract identifier. The market data may include the call prices, and/or put prices for each of the options contracts having different expiries. The market data may include an option code that may distinguish the calls and the puts for each option. For example, the option code may be ‘0’ for a call and ‘1’ for a put, or vice versa.

The market data may include other market data for the futures contracts underlying various options. For example, the market data may include the inside market (e.g., highest available bid and lowest available offer), market depth (e.g., volume available at price levels including the inside market), a last traded price, and/or price levels associated with the inside market and market depth. The value levels may be a net change from an opening price for the futures contract.

The computing device may identify options related to specific futures contracts in the market data at 504. For example, the computing device may select one or more futures contract identifiers and may filter out options having underlying tradeable object identifiers that differ from the selected futures contract identifier or identifiers. The futures contract identifiers may be selected by a user indication from a user interface, for example.

The computing device may group the options of the underlying tradeable objects by options contract expiry at 506. For example, the computing device may group the options, and the option information related thereto, by the contract expiration date associated with each underlying tradeable object. The method 500 may process the groups of futures contracts having the same futures contract expiries to display lists of relevant strike prices and/or other option information for various groups of options to a user.

The computing device may determine, at 508, whether to process a group of options at 508. For example, the computing device may determine whether each of the groups of options that were grouped together by options contract expiry at 506 have been processed to determine the list of relevant strike prices to be displayed to a user. The groups of options that have already been processed may be stored with a flag that may indicate that the group has already been processed at the computing device. If the computing device determines that each of the groups of options have been processed at 508, the method 500 may exit at 510. If the computing device decides to process one or more of the groups of options at 508, the method 500 may continue to FIG. 5B for processing. Though the computing device may process each of the groups of options determined at 506, the computing device may also, or alternatively, be configured to process a subset (e.g., one or more) of the groups of options determined at 506. The subsets may be predefined or user configured, for example. The subsets may include the groups of options for which updated market data is received at 502 since the group of options was previously processed.

As shown in FIG. 5B, a group of options having the same expiry for an underlying tradeable object may be sorted by strike price and option code at 512. For example, the options may be sorted in ascending or descending order according to strike price. The computing device may also sort the options by option code at 512, such that options having the same strike price may be grouped in ascending or descending order according to option code (e.g., indicating call or put).

An example of a group of options being sorted at 512 is illustrated by the following array: [ES Mar 15 C 2000, ES Mar 15 P 2000, ES Mar 15 C 2005, ES Mar 15 P 2005 . . . ES Mar 15 C 2085, ES Mar 15 P 2085], where each entry is delimited by a comma, the “ES Mar 15” may be the identifier of the options contract expiry within the group, the “C” and “P” may be the option code (e.g., call or put) for each entry in the array, and each entry may include the strike price for the expiry. As described above, the call and put may be indicated with other option codes, such as a ‘0’ and ‘1’ for example. The group of options may also include the call price or the strike price for each entry, if one exists.

As illustrated in the array data provided above, the group of options for an underlying tradeable object may be sorted by strike price, with the option code being used to determine an order between the entries in the group having a call and a put for the same strike price. The options being sorted according to option code may allow the call or the put the options having the same strike price to be identified based on the order within the list of options. Though the computing device may sort the options having the same strike price by option code at 512, the computing device may just sort the group of options by strike price. The option code may still be used to identify the call or the put for each strike price.

The computing device may generate an indexed array of the options objects for each strike price at 514. Each options object may be represented by an object that has a strike price and an array of the options that match the strike price. Each options object may be given an index value for a given strike price. The array of options for each options object may include options having a respective call and a respective put for a given strike price. The call value and the put value may be set to the call price and the put price received in the market data for the strike price identified by the index value. Where the market data does not include a call price or a put price for the given indexed strike price, the respective call value or put value may be set to a null value or zero.

The indexed array of options objects for each strike price may be generated at 514 by iterating the sorted list of options created at 512 and comparing each option's strike price to the strike price of the prior option in the list. When a different strike price is found in the list of sorted options, an options object may be created. The initial value in the list of sorted options may be set to a null value or a zero value to differentiate the first set of strike prices for the options in the list, or an object may automatically be created for the options having the initial set of strike prices.

An example of the indexed array of options objects for each strike price may be illustrated by the following array, using the same group of futures contracts illustrated above in the sorted array of futures contracts: [Index 0: 2000: ES Mar 15 C 2000, ES Mar 15 P 2000; Index 1: 2005: ES Mar 15 C 2005, ES Mar 15 P 2005; . . . Index 17: 2085: ES Mar 15 C 2085, ES Mar 15 P 2085], where each options object is delimited by a semicolon. Each options object may include an index identifier that identifies the index number and/or the strike price for the index. Each options object may also identify the options contract expiry within the group, the options having the strike price identified by the index identifier, the option code (e.g., call or put) for each entry in the options object, or a combination thereof. Each options object may also include the call price or the strike price for each entry, if one exists.

The value of a target strike price may be determined at 516. The target strike price is chosen as the strike price around which the option strike prices for a group of options may be centered to display relevant strike prices for the group of options to a user (e.g., when a subset of strike prices for a group of options may be displayed to a user). The target strike price may be the price at which the market may be centered for groups of options related to an underlying tradeable object. For example, the target strike price may be the midpoint between the highest available bid and the lowest available offer for the futures contract underlying the group of options, the lowest available offer for the futures contract underlying the group of options, the highest available bid for the futures contract underlying the group of options, the last traded price for the futures contract underlying the group of options, the midpoint between the high and low traded price for the futures contract within a predefined period of time (e.g., a day), the high traded price for the futures contract within the predefined period of time, the low traded price for the futures contract within the predefined period of time, the settlement price for the futures contract underlying the group of options, or another target strike price between the highest and lowest strike prices within the group of options. The target strike price may be equal to the strike price of an options object in the indexed array of options objects or another target strike price from which a list of strike prices may be identified for being displayed. Though a single target strike price may be described from which a list of strike prices may be identified for being displayed, one or more target strike prices may be used to identify the list of strike prices for being displayed.

The computing device may determine, at 518, a difference between the target strike price and the strike price for each indexed options object in the array generated at 514. The difference may be represented as an absolute value of the difference between the target strike price and the strike price for each indexed options object. The difference between the target strike price and the strike price for the indexed options objects may be used to select which strike prices to display to a user.

The computing device may determine, at 520, the predefined range of strike prices for being displayed to the user in the user interface. The predefined range of strike prices may be five strike prices, as shown in interface 400 in FIG. 4, for example. However, any other number of strike prices may be selected for the predefined range of strike prices. The predefined range of strike prices may be user selected or may be otherwise defined at the computing device. The predefined range of strike prices may be dynamically updated according to the amount of space available in the interface being displayed.

The predefined range of strike prices may include either an even or an odd number of strike prices to be displayed. The computing device may determine the options object or objects in the indexed array with the smallest difference between the strike price and the target strike price at 522. The options object or objects in the indexed array with the smallest difference between the strike price and the target strike price may be the center strike price or center strike prices. The center strike price or center strike prices may be used to center the strike prices for being displayed in the predefined range of strike prices in the user interface. If the predefined range of strike prices includes an odd number of strike prices, the computing device may determine the strike price of an options object in the indexed array with the smallest difference between the strike price and the target strike price as the center strike price. If the predefined range of strike prices includes an even number of strike prices, the computing device may determine the strike prices of two options objects in the indexed array with the smallest differences between the strike price and the target strike price as the center strike prices.

The computing device may use the strike price for the options object or objects determined at 522 (e.g., the options object or objects closet target strike price) as the center strike price or strike prices to be displayed in the middle of a predefined range of strike prices in a graphical user interface. For example, the computing device may count (from the center strike price or prices) up a certain number of strike prices toward an upper bound of the indexed array of options objects and/or down a certain number of strike prices toward a lower bound of the indexed array of options objects to define the predefined range of strike prices for being displayed in the user interface. Where the predefined range of strike prices is five, for example, the computing device may count up two options objects and down two options objects from the options object having the center strike price to define the range of strike prices for being displayed.

The computing device may determine whether the predefined range of strike prices exceed the upper or lower bound of the indexed array of options objects at 524. For example, the computing device may determine whether the number of strike prices above or below the center strike price or strike prices to be counted for being included in the predefined range exceeds the upper or lower bound of the indexed array, respectively. If the upper or lower bound of the indexed array would not be exceeded by the predefined range of strike prices being counted from the center strike price or strike prices, the computing device may determine the closest relative strike prices for the options objects in the indexed array above and below the center strike price or strike prices at 526 and may display the strike prices within the predefined range at 530. If the upper or lower bound of the indexed array would be exceeded by the predefined range of strike prices being counted from the center strike price or strike prices, the computing device may determine the strike prices of the closest relative indexed options objects within the predefined range of the upper or lower bound of the indexed array of options objects at 528 and may display the strike prices within the predefined range at 530. The strike prices may be displayed at 530 with other option information, such as the call price and/or the put price for the options object from which the strike price is being displayed.

The number of strike prices displayed above and below the center strike price or strike prices in the predefined range may be the same or different. For example, to define the strike prices to display in the predefined range of strike prices, the computing device identifies may include an equal number of strike prices above and below the center strike price when the predefined range of strike prices is an odd number. If, for example, a predefined range of strike prices is an even number, the computing device may define two center strike prices. For example, the computing device may identify two center strike prices closest to the target strike price. In order to adjust the range to accommodate a pair of center strike prices, the computing device determines which of the identified center strike prices is closest to the target strike price. For example, the computing device determines which of the two center two center strike price is closest to the target strike price. The center strike price identified as closet to the target strike price is, in turn, evaluated to determine if it is greater than the target strike price. If the closest strike price is greater than the target strike price, then an additional strike price is included below the center strike prices, else the additional strike price is included above the center strike prices. In another example, the computing device may include the strike prices that are the closest strike prices to the target strike price or the center strike price, without considering the number of strike prices above or below the target strike price or the center strike price.

Referring again to the method 500 shown in FIGS. 5A and 5B, the method 500 may return to 508, as shown in FIG. 5A, after displaying the strike prices within the predefined range at 530 to determine whether to process another group of options for being displayed. If market data is received at 502 related to a futures contract that has already been processed at 508, the computing device may determine at 508 whether to process the group of options again to adjust the options currently being displayed in the interface. For example, the strike prices may be recentered for being displayed in the predefined range of strike prices. The computing device may determine to process the group of options to adjust the options being displayed if the center strike price or one or more of the center strike prices for a group of options go outside of the strike prices currently being displayed in the predefined range. For example, where the predefined range of strike prices includes five strike prices, the computing device may decide to process the group of options for displaying an updated list of strike prices when the center strike price, or one of the center strike prices, is outside of the five strike prices currently being displayed. This may allow for some fluctuation in the center strike price without an update being triggered each time the center strike price changes.

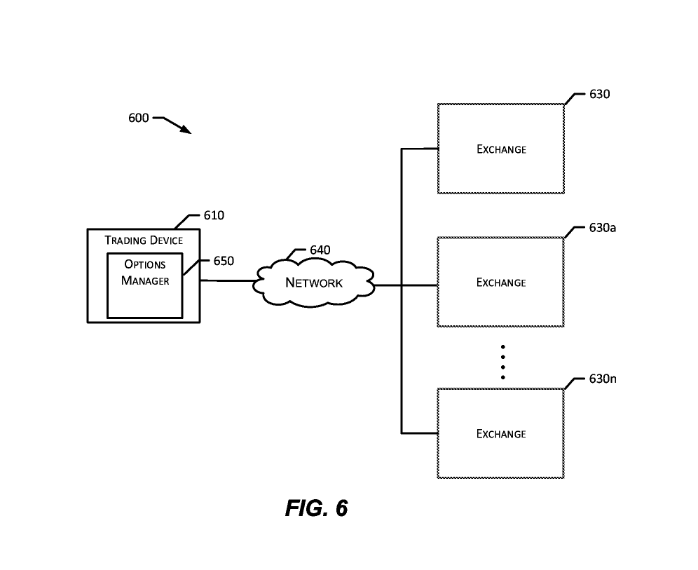

FIG. 6 illustrates a block diagram of an example system 600 that may be used to generate and/or provide option information related to one or more tradeable objects, such as underlying tradeable objects, at one or more electronic exchanges. The system 600 may include a trading device 610 that may receive market data from one or more exchanges, such as exchange 630 and/or exchanges 630a to 630n. The trading device 610 may communicate with the exchanges directly or through a network 640. The market data from the exchanges 630 to 630n may correspond to one or more tradeable objects (e.g., futures contracts) at each market.

The market data may include information related to one or more futures contracts. The market data for a futures contract may include the inside market, market depth, a last traded price, and/or price levels associated with the inside market and market depth. The market data may include option information for one or more underlying tradeable objects. For example, the market data may include a number of options related to an underlying tradeable object and/or a strike price for each option. The option information may also include a call price or a put price for the option. The option information may indicate whether the option is a call or a put via an option code.

The market data may be received at the trading device 610 in response to a query from the trading device 610 or in an update message received periodically from the exchanges 630 to 630n. The market data may be received from the exchanges 630 to 630n response to an update of the market data for one or more tradeable objects at the exchanges 630 to 630n. The trading device 610 may store the market data locally, at a remote device, or the market data may be distributed across multiple devices. For example, the trading device 610 may include a trading terminal and a trading server at which the market data may be stored.

The trading device 610 may be capable of generating and/or displaying a user interface that may indicate relevant information related to available options on a market as described herein. As described above, the trading device 610 may be a trading server and/or a trading terminal. The functionality described herein may be performed on the trading terminal, the trading server, or may be distributed across the trading terminal and the trading server. For example, the trading device 610 may include a trading terminal capable of displaying a user interface for an application executing locally on the trading terminal or an application executing remotely on the trading server and accessed on an application at the trading terminal (e.g., via a web browser or other application).

The trading device 610 may include an options manager 650, which may be executed locally at the trading terminal, at the trading server, or may be distributed across the trading terminal and the trading server. The options manager 650 may perform analysis for generating a user interface that provides relevant information related to available options on a market. For example, the options manager 650 may receive market data, analyze the market data, and/or generate a user interface that provides relevant information related to available options on a market. The options manager 650 may identify relevant options related to one or more underlying tradeable objects, group the options, and may display a predefined range of options that are representative of the current market. The options manager 650 may identify relevant options based on the proximity of the strike prices of the options to a target strike price. The target strike price may represent the strike price for the current market for a group of options underlying a futures contract. The options manager 650 may perform one or more of the embodiments described herein, or portions thereof, to generate and/or display a user interface that provides the relevant option information for a group of options.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed:

1. A method for generating and displaying option information related to underlying tradeable objects, the method comprising:
receiving, via an options manager, market data related to a futures contract tradeable at an electronic exchange;
identifying, via the options manager, options in the market data that are related to the futures contract;
grouping, via the options manager, the options into different groups, wherein each group of options is related to a different options contract expiry;
processing, via the options manager, a group of options to determine a predefined range of strike prices to display via a user interface, wherein the processing further comprises:
sorting the group of options by strike price;
determining a target strike price between a highest and a lowest strike price related to the group of options;
determine at least one center strike price related to the group of options based on the target strike price, wherein the at least one center strike price comprises a closest relative strike price to the target strike price of the options in the group of options;
identifying an equal number of strike prices above and below the at least one center strike price for being included in the predefined range of strike prices to display, wherein the strike prices above the at least one center strike price are the closest relative strike prices above the at least one center strike price of the options within the group of options, and wherein the strike prices below the at least one center strike price are the closest relative strike prices below the at least one center strike price of the options within the group of options;
including the at least one center strike price and the identified strike prices above and below the at least one center strike price in the predefined range of strike prices to display; and
displaying, via the options manager, the predefined range of strike prices via the user interface.

2. The method of claim 1, wherein the group of options is further sorted by option code, wherein the option code indicates whether an option is related to a call price or a put price for the option.

3. The method of claim 2, further comprising:
generating, via the options manager, an indexed array of options objects for each strike price in the group of options, wherein each options object in the indexed array of options objects comprises the strike price corresponding to at least one option in the group of options.

4. The method of claim 3, wherein each indexed array of options objects for the group of options is generated by identifying a next strike price in the sorted group of options and generating an index for the next strike price, and wherein the options objects include options having a same strike price and a different option code.

5. The method of claim 1, further comprising:
displaying, via the options manager, at least one of a call price or a put price for each strike price in the predefined range of strike prices when the call price or the put price are available.

6. The method of claim 1, wherein the group of options comprises a first group of options related to a first options contract expiry, and wherein the predefined range of strike prices comprises a first predefined range of strike prices, the method further comprising:
processing, via the options manager, a second group of options related to a second options contract expiry to determine a second predefined range of strike prices to display via the user interface; and
displaying, via the options manager, the second predefined range of strike prices via the user interface.

7. The method of claim 6, further comprising:
displaying, via the options manager, at least one of a call price or a put price for each strike price in the second predefined range of strike prices when the call price or the put price are available.

8. The method of claim 1, wherein the futures contract is a first futures contract, wherein the group of options comprises a first group of options related to a first options contract expiry for the futures contract, and wherein the predefined range of strike prices comprises a first predefined range of strike prices, the method further comprising:
receiving, via the options manager, market data related to a second futures contract tradeable at the electronic exchange;
identifying, via the options manager, options in the market data that are related to the second futures contract;
grouping, via the options manager, the options related to the second futures contract into a second group of futures contracts related to a second options contract expiry;
processing, via the options manager, the second group of options to determine a second predefined range of strike prices to display via the user interface; and
displaying, via the options manager, the second predefined range of strike prices via the user interface.

9. The method of claim 1, wherein the options manager resides on a trading device.

10. The method of claim 9, wherein the trading device comprises a trading terminal and a trading server, and wherein the options manager comprises software distributed across the trading terminal and the trading server that is executed by respective processors at the trading terminal and the trading server.

11. A method for generating and displaying option information related to underlying tradeable objects, the method comprising:
receiving, via an options manager, market data related to a futures contract tradeable at an electronic exchange;
identifying, via the options manager, options in the market data that are related to the futures contract;
grouping, via the options manager, the options into different groups, wherein each group of options is related to a different options contract expiry;
processing, via the options manager, a group of options to determine a predefined range of strike prices to display via a user interface, wherein the processing further comprises:
determining at least one center strike price related to the group of options;
identifying an equal number of strike prices above and below the at least one center strike price within the predefined range of strike prices, wherein the strike prices above the at least one center strike price are the closest relative strike prices above the at least one center strike price of the options within the group of options, and wherein the strike prices below the at least one center strike price are the closest relative strike prices below the at least one center strike price of the options within the group of options;
including the at least one center strike price and the identified strike prices above and below the at least one center strike price in the predefined range of strike prices to display; and
displaying, via the options manager, the predefined range of strike prices via the user interface.

12. The method of claim 11, wherein processing each group of options further comprises:
sorting the group of options by strike price;
determining a target strike price between a highest and a lowest strike price related to the group of options; and
determining the at least one center strike price related to the group of options based on the target strike price, wherein the at least one center strike price comprises a closest relative strike price to the target strike price of the options in the group of options.

13. The method of claim 12, wherein the group of options are further sorted by option code, wherein the option code indicates whether an option is related to a call price or a put price for the option.

14. The method of claim 13, further comprising:
generating, via the options manager, an indexed array of options objects for each strike price in the group of options, wherein each options object in the indexed array of options objects comprises the strike price corresponding to at least one option in the group of options.

15. The method of claim 14, wherein each indexed array of options objects for the group of options is generated by identifying a next strike price in the sorted group of options and generating an index for the next strike price, and wherein the options objects include options having a same strike price and a different option code.

16. The method of claim 11, further comprising:
displaying, via the options manager, at least one of a call price or a put price for each strike price in the predefined range of strike prices when the call price or the put price are available.

17. The method of claim 11, wherein the group of options comprises a first group of options related to a first options contract expiry, and wherein the predefined range of strike prices comprises a first predefined range of strike prices, the method further comprising:
processing, via the options manager, a second group of options related to a second options contract expiry to determine a second predefined range of strike prices to display via the user interface; and
displaying, via the options manager, the second predefined range of strike prices via the user interface.

18. The method of claim 11, wherein the futures contract is a first futures contract, wherein the group of options comprises a first group of options related to a first options contract expiry for the futures contract, and wherein the predefined range of strike prices comprises a first predefined range of strike prices, the method further comprising:
receiving, via the options manager, market data related to a second futures contract tradeable at the electronic exchange;
identifying, via the options manager, options in the market data that are related to the second futures contract;
grouping, via the options manager, the options related to the second futures contract into a second group of futures contracts related to a second options contract expiry;
processing, via the options manager, the second group of options to determine a second predefined range of strike prices to display via the user interface; and
displaying, via the options manager, the second predefined range of strike prices via the user interface.

19. The method of claim 11, wherein the options manager resides on a trading device.

20. The method of claim 19, wherein the trading device comprises a trading terminal and a trading server, and wherein the options manager comprises software distributed across the trading terminal and the trading server that is executed by a respective processor at the trading terminal and the trading server.
